(19) United States
(12) Patent Application Publication
(10) Pub. No.: US 2026/0343363 A1
(43) Pub. Date: Oct. 29, 2026

(54) INFORMATION PROCESSING SYSTEM, INFORMATION PROCESSING DEVICE, AND INFORMATION PROCESSING METHOD

(71) Applicant: NEC Corporation, Minato-ku, Tokyo (JP)

(72) Inventor: Yasuhiro MIZUKOSHI, Tokyo (JP)

(73) Assignee: NEC Corporation, Minato-ku, Tokyo (JP)

(21) Appl. No.: 19/110,912

(22) PCT Filed: Sep. 29, 2022
(86) PCT No.: PCT/JP2022/036356

§ 371 Date: Mar. 12, 2025

(51) Int. Cl. H04W 36/18; H04W 40/12

(52) U.S. Cl. CPC H04W 36/18; H04W 40/12

(57) ABSTRACT

To maintain, even in a case where a communication state changes during communication, stability of wireless communication, an information processing system includes: a specifying means that specifies a selection method for selecting a wireless communication line for transmitting data obtained in a movable body, in accordance with a predicted bandwidth indicating a range of temporal variation in a bandwidth which variation is predicted for each of a plurality of the wireless communication lines; and a first selecting means that refers to the selection method specified, to select, while the data is being transmitted, one or more of the plurality of the wireless communication lines each for transmitting the data.

### TECHNICAL FIELD

The present invention relates to an information processing system, an information processing apparatus, and an information processing method.

### BACKGROUND ART

Recent increases in communication traffic have been remarkable, but it is not easy to correspondingly increase the capacity of communication facilities. Therefore, various methods for ensuring the quality of communication by efficiently using existing facilities have been studied.

For example, Patent Literature 1 discloses a network control apparatus including a link information managing section that notifies quality information on wireless links formed by a plurality of communication apparatuses dispersedly disposed, to another communication apparatus, a line quality predicting section that predicts variation in the communication qualities of the wireless links on the basis of the quality information, and a path controlling section that determines a path that transmits traffics between transmitting and receiving communication apparatuses, on the basis of a result of the prediction. This configuration is said to be able to improve the line operation rate and the throughput as the entire network.

Patent Literature 2 discloses a path control system including a path controlling apparatus that, with respect to a wireless link using adaptive modulation, preferentially sets, to the network, a communication path with a bandwidth probability higher than a predetermined threshold, which probability indicates a stability of the bandwidth and that prepares an alternative path for a communication path with a bandwidth probability lower than the predetermined threshold. This is said to enable high-quality communication.

### CITATION LIST

### Patent Literature

[Patent Literature 1]

Japanese Patent Application Publication, Tokukai, No. 2014-179869

[Patent Literature 2]

International Publication No. WO2010/090311

### SUMMARY OF INVENTION

### Technical Problem

With the technique described in Patent Literature 1 or Patent Literature 2, even if the transmission path or the communication path has been once determined, the communication state may change during wireless communication. This is because wireless communication is easily affected by changes in the environment and by other wireless communication apparatuses. An example aspect of the present invention has been made in light of the foregoing problem, and it is one example object thereof to provide a technology for maintaining stability of wireless communication, even in a case where the communication state changes during communication.

### Solution to Problem

An information processing system in accordance with an example aspect of the present invention includes: a specifying means that specifies a selection method for selecting a wireless communication line for transmitting data obtained in a movable body, in accordance with a predicted bandwidth indicating a range of temporal variation in a bandwidth which variation is predicted for each of a plurality of the wireless communication lines; and a first selecting means that refers to the selection method specified, to select, while the data is being transmitted, one or more of the plurality of the wireless communication lines each for transmitting the data.

An information processing apparatus in accordance with an example aspect of the present invention includes: a specifying means that specifies a selection method for selecting a wireless communication line for transmitting data obtained in a movable body, in accordance with a predicted bandwidth indicating a range of temporal variation in a bandwidth which variation is predicted for each of a plurality of the wireless communication lines; and a first selecting means that refers to the selection method specified, to select, while the data is being transmitted, one or more of the plurality of the wireless communication lines each for transmitting the data.

An information processing method in accordance with an example aspect of the present invention includes: specifying a selection method for selecting a wireless communication line for transmitting data obtained in a movable body, in accordance with a predicted bandwidth indicating a range of temporal variation in a bandwidth which variation is predicted for each of a plurality of the wireless communication lines; and referring to the selection method specified, to select, while the data is being transmitted, one or more of the plurality of the wireless communication lines each for transmitting the data, the specifying and the referring being each carried out by at least one processor.

### Advantageous Effects of Invention

An example aspect of the present invention makes it possible to maintain stability of wireless communication, even in a case where a communication state changes during communication.

### BRIEF DESCRIPTION OF DRAWINGS

FIG. 1 is a block diagram illustrating a configuration of an information processing system 1 in accordance with a first example embodiment of the present invention.

FIG. 2 is a block diagram illustrating a configuration of an information processing apparatus 2 in accordance with the first example embodiment.

FIG. 3 is a flowchart illustrating a flow of an information processing method S1 in accordance with the first example embodiment.

FIG. 4 is a block diagram illustrating a configuration of an information processing system 1A in accordance with a second example embodiment.

FIG. 5 is a view schematically illustrating one example of a selection method that allows a first selecting section to select a wireless communication line that transmits image data.

FIG. 6 is a view schematically illustrating one example of an allocation bandwidth map generated by the first selecting section.

FIG. 7 is a view schematically illustrating one example of an allocation bandwidth map generated by the first selecting section.

FIG. 8 is a view schematically illustrating one example of an allocation bandwidth map generated by the first selecting section.

FIG. 9 is a view schematically illustrating one example of an allocation bandwidth map generated by the first selecting section.

FIG. 10 is a view schematically illustrating a method for switching allocation bandwidth maps in accordance with a communication area.

FIG. 11 is a block diagram illustrating a configuration of an information processing apparatus 2A in accordance with the second example embodiment.

FIG. 12 is a flowchart illustrating a flow of an information processing method S2 in accordance with the second example embodiment.

FIG. 13 is a block diagram illustrating a configuration of an information processing system 1B in accordance with a third example embodiment.

FIG. 14 is a block diagram illustrating a configuration of an information processing system 2B in accordance with the third example embodiment.

FIG. 15 is a view illustrating a configuration for achieving the information processing apparatus with use of software.

### EXAMPLE EMBODIMENTS

### First Example Embodiment

The following description will discuss a first example embodiment of the present invention in detail with reference to the drawings. The present example embodiment is a basic form of example embodiments described later. An information processing system 1 in accordance with the present first example embodiment is a wireless communication system for stably transmitting and receiving data, even in a case where a transmitting apparatus moves.

### (Configuration of Information Processing System 1)

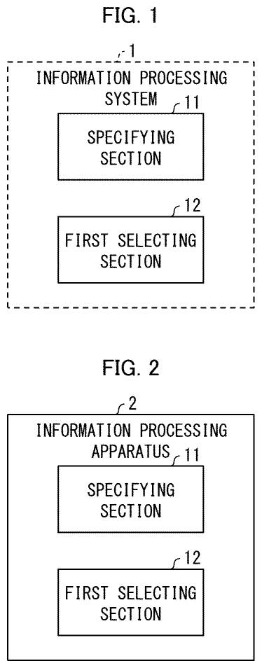

With reference to FIG. 1, the following description will discuss a configuration of the information processing system 1 in accordance with the present example embodiment. FIG. 1 is a block diagram illustrating a configuration of the information processing system 1.

The information processing system 1 includes a specifying section 11 and a first selecting section 12. The specifying section 11 specifies a selection method for selecting a wireless communication line for transmitting data obtained in a movable body, in accordance with a predicted bandwidth indicating a range of temporal variation in a bandwidth which variation is predicted for each of a plurality of wireless communication lines. The data is, for example, image data including static images and/or moving images, audio data, or the like. The specifying section 11 is one form of a specifying means in the claims.

In the present example embodiment, the wireless communication line is, for example, any of wireless communication lines including a line configured according to a mobile communication standard, such as LTE, 4G, or 5G (hereinafter, collectively referred to also as “LTE line”), a line configured according to a short-range wireless communication standard, such as Wi-Fi (registered trademark) (hereinafter, also referred to as “Wi-Fi (registered trademark) line”), a satellite communication line, and the like.

The bandwidth is an amount of data that can be transmitted via the wireless communication line and is represented by, for example, a bit rate or a frame rate of the data. A transmitting apparatus not illustrated moves, and thus a bandwidth varies over time in accordance with a temporal change in the communication environment. It is possible to predict, by a known method, how and how much the bandwidth varies. The range of the variation in the bandwidth predicted is referred to as “predicted bandwidth”. The selection method will be described later in detail.

The first selecting section 12 refers to the selection method specified by the specifying section 11, to select one or more wireless communication lines that transmit data, from among a plurality of wireless communication lines while the data is being transmitted. Specifically, the expression “select a wireless communication line while data is being transmitted” means, for example, selecting a wireless communication line to be used for transmission, from among the plurality of wireless communication lines during a time from a time point at which the first one of a plurality of packets into which the data had been divided was transmitted to a time point at which the last one of the packets has been transmitted. A transmitting apparatus 10 can transmit data with use of the wireless communication line selected by the first selecting section 12. The first selecting section 12 is one form of a first selecting means in the claims.

The specifying section 11 and the first selecting section 12 need not be disposed in one housing and may be dispersedly disposed in different housings and be connected to each other so as to enable information communication. The specifying section 11 and the first selecting section 12 may be at least partially disposed on a cloud. The above configuration in which at least part of the sections or at least part of the apparatuses may be dispersedly disposed or be disposed on a cloud applies to the following example embodiments as well.

As described above, the information processing system 1 in accordance with the present example embodiment employs a configuration of including: a specifying means that specifies a selection method for selecting a wireless communication line for transmitting data obtained in a movable body, in accordance with a predicted bandwidth indicating a range of temporal variation in a bandwidth which variation is predicted for each of a plurality of the wireless communication lines; and a selecting means that refers to the selection method specified, to select, while the data is being transmitted, one or more of the plurality of the wireless communication lines each for transmitting the data. Therefore, the information processing system 1 in accordance with the present example embodiment provides an example advantage of making it possible to maintain stability of wireless communication, even in a case where the communication state changes during communication. That is, it is possible to transmit data without breaks or deterioration, even in a case where the communication state changes during communication.

### (Configuration of Information Processing Apparatus 2)

Now turning to FIG. 2, the following description will discuss a configuration of an information processing apparatus 2 in accordance with the present example embodiment. FIG. 2 is a block diagram illustrating a configuration of the information processing apparatus 2. As illustrated in the drawing, the information processing apparatus 2 includes a specifying section 11 and a first selecting section 12.

The specifying section 11 specifies a selection method for selecting a wireless communication line for transmitting data obtained in a movable body, in accordance with a predicted bandwidth indicating a range of temporal variation in a bandwidth which variation is predicted for each of a plurality of wireless communication lines. The bandwidth, data, wireless communication line, and the like are as described for the configuration of the information processing system 1. The first selecting section 12 refers to the specified selection method to select, during the transmission, one or more wireless communication lines that transmit data, from among the plurality of wireless communication lines. The selection method will be described later in detail.

As described above, the information processing apparatus 2 in accordance with the present example embodiment employs a configuration of including: a specifying means that specifies a selection method for selecting a wireless communication line for transmitting data obtained in a movable body, in accordance with a predicted bandwidth indicating a range of temporal variation in a bandwidth which variation is predicted for each of a plurality of the wireless communication lines; and a selecting means that refers to the selection method specified, to select, while the data is being transmitted, one or more of the plurality of the wireless communication lines each for transmitting the data. Therefore, the information processing system 1 in accordance with the present example embodiment provides an example advantage of making it possible to maintain stability of wireless communication, even in a case where the communication state changes during communication.

### (Flow of Information Processing Method S1)

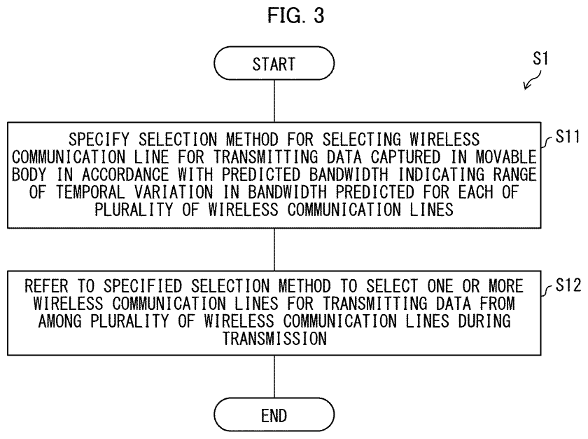

Now turning to FIG. 3, the following description will discuss a flow of an information processing method S1 in accordance with the present example embodiment. FIG. 3 is a flowchart illustrating a flow of the information processing method S1.

As illustrated in the drawing, the information processing method S1 includes a step S11 and a step S12. The step S11 is a step of, by at least one processor (for example, the specifying section 11), specifying a selection method for selecting a wireless communication line for transmitting data obtained in a movable body, in accordance with a predicted bandwidth indicating a range of temporal variation in a bandwidth which variation is predicted for each of a plurality of wireless communication lines.

The step S12 is a step of, by at least one processor (for example, the first selecting section 12), referring to the specified selection method to select, during the transmission, one or more wireless communication lines that transmit data, from among a plurality of wireless communication lines.

According to the above information processing method S1, a wireless communication line in accordance with the predicted bandwidth is selected, and the data is transmitted via the line. This provides an example advantage of making it possible to maintain stability of wireless communication, even in a case where the communication state changes during communication.

As described above, the information processing method S1 in accordance with the present example embodiment employs a configuration of including: specifying a selection method for selecting a wireless communication line for transmitting data obtained in a movable body, in accordance with a predicted bandwidth indicating a range of temporal variation in a bandwidth which variation is predicted for each of a plurality of the wireless communication lines; and referring to the selection method specified, to select, while the data is being transmitted, one or more of the plurality of the wireless communication lines each for transmitting the data, the specifying and the referring being each carried out by at least one processor. Therefore, the information processing method S1 in accordance with the present example embodiment provides an example advantage of making it possible to maintain stability of wireless communication, even in a case where the communication state changes during communication.

### Second Example Embodiment

The following description will discuss a second example embodiment of the present invention in detail with reference to the drawings. The same reference numerals are given to constituent elements having the same functions as those described in the first example embodiment, and descriptions of such constituent elements are omitted as appropriate.

### (Configuration of Information Processing System 1A)

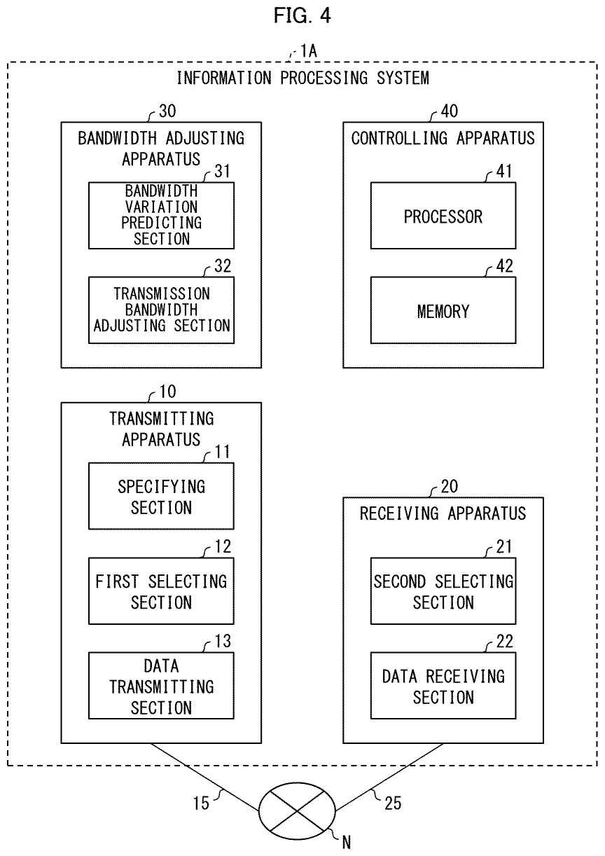

FIG. 4 is a block diagram illustrating a configuration of an information processing system 1A in accordance with the second example embodiment. As illustrated in the drawing, the information processing system 1A includes a transmitting apparatus 10, a receiving apparatus 20, a bandwidth adjusting apparatus 30, and a controlling apparatus 40. As one example, the information processing system 1A can be used for a monitoring system configured to transmit and receive an image from a camera mounted in a movable body to monitor whether or not there is any problem. As described above, the transmitting apparatus 10, the receiving apparatus 20, the bandwidth adjusting apparatus 30, and the controlling apparatus 40 may be disposed in different locations. For example, the capturing apparatus and the transmitting apparatus 10 may be disposed in a car serving as the movable body, and the receiving apparatus 20 may be disposed in a monitoring center or the like. Either or both of the bandwidth adjusting apparatus 30 and the controlling apparatus 40 may be disposed on a cloud or in the monitoring center. The following example embodiment will be described taking, as an example, a case where data is image data captured by a capturing means.

The transmitting apparatus 10 includes a specifying section 11, a first selecting section 12, and a data transmitting section 13. The functions of the specifying section 11 and the first selecting section 12 are the same as those of the specifying section 11 and the first selecting section 12 described in the first example embodiment. The data transmitting section 13 transmits image data via a wireless communication line 15 selected. The transmitting apparatus 10 is, for example, an apparatus that obtains image data captured in a movable body and transmits the image data through wireless communication. The image data captured in a movable body is, for example, image data captured by a capturing apparatus (capturing means), such as a camera, mounted in a movable body, such as a car, a train, an aircraft, or a ship. Alternatively, the image data may be an image captured by a capturing apparatus that can be carried by a human. Such image data is image data with an imaging position that may change over time. The imaging position may change continuously or may change intermittently. The transmitting apparatus 10 obtains the image data from the capturing apparatus in a real-time manner. That is, the transmitting apparatus 10 moves together with the capturing apparatus that has captured the image data. The transmitting apparatus 10 may be formed integrally with the capturing apparatus.

The receiving apparatus 20 includes a second selecting section 21 and a data receiving section 22. The receiving apparatus 20 receives image data transmitted from the transmitting apparatus 10. The data receiving section 22 receives image data transmitted from the transmitting apparatus 10. In a case where a plurality of wireless communication lines 15 that each transmit image data are selected by the first selecting section 12 of the transmitting apparatus 10, the second selecting section 21 selects one of a plurality of pieces of image data received. That is, in a case where a plurality of wireless communication lines 15 that each transmit image data are selected by the first selecting section 12, the same image data is transmitted for each of the plurality of wireless communication lines. Therefore, the second selecting section 21 selects image data of good visual quality from among the plurality of pieces of image data received. The selected image data may be displayed on a display apparatus not illustrated or may be stored. The image data not selected is not displayed, and may not be stored.

The image data is, for example, transmitted and received via the Internet N, as illustrated in FIG. 4. More specifically, the image data is transmitted from the transmitting apparatus 10 to the connection point closest to the Internet N via at least one of the plurality of wireless communication lines 15. The image data is received by the receiving apparatus 20 from the connection point with the Internet N closest to the receiving apparatus 20 via a wired communication circuit 25 or a wireless communication line 25. The receiving apparatus 20 is one form of a receiving means in the claims. The second selecting section 21 is one form of a second selecting means in the claims.

Typically, a single line is used as the line 25 from the Internet N to the receiving apparatus 20. The reason for this is, for example, that since the receiving apparatus 20 installed in the monitoring center does not move and exists in a fixed location, it is possible to use a wired communication line, which is stable, or it is sufficient to use a wireless communication line of the best quality in that location.

The bandwidth adjusting apparatus 30 refers to the predicted bandwidth to adjust a bandwidth in which the image data is transmitted, for each of the plurality of wireless communication lines 15. The bandwidth adjusting apparatus 30 includes a bandwidth variation predicting section 31 and a transmission bandwidth adjusting section 32. The bandwidth variation predicting section 31 predicts a predicted bandwidth indicating how much the bandwidth in the near future will be, for each of the wireless communication lines 15. The bandwidth variation predicting section 31 may, for example, obtain information on temporal variation in a bandwidth and predict, from the tendency of the variation, a tendency of variation in the bandwidth in the near future. Alternatively, the bandwidth variation predicting section 31 may predict the bandwidth variation with use of a bandwidth predicting model that predicts, from the past variation in the bandwidth, variation in the near future. The range of temporal variation in the bandwidth predicted is referred to as “predicted bandwidth”. The “near future” may refer to several minutes ahead, several tens of minutes ahead, or several hours ahead. The prediction is carried out as appropriate by the bandwidth variation predicting section 31, and the predicted bandwidth is updated.

The transmission bandwidth adjusting section 32 refers to the predicted bandwidth predicted for each of the plurality of wireless communication lines 15 to adjust a transmission bandwidth, which is a bandwidth in which the image data is transmitted. That is, in a case where it is predicted that the bandwidth of a certain wireless communication line 15 will decrease, the bandwidth adjusting apparatus 30 sets, to be small, the transmission bandwidth of the image data that is transmitted via the wireless communication line 15. In contrast, in a case where it is predicted that the bandwidth of a certain wireless communication line 15 will increase, the bandwidth adjusting apparatus 30 sets, to be large, the transmission bandwidth of the image data that is transmitted via the wireless communication line 15. The transmission bandwidth adjusting section 32 may adjust the transmission bandwidth of the image data, for each of the plurality of wireless communication lines 15. The bandwidth adjusting apparatus 30 is one form of a bandwidth adjusting means in the claims.

The controlling apparatus 40 collectively controls the entire information processing system 1A. The controlling apparatus 40 includes at least one processor 41 and at least one memory 42. The processor 41 can be constituted by, for example, at least one general-purpose processor, such as a micro processing unit (MPU) or a central processing unit (CPU). The memory 42 may include memories of different types, such as a read only memory (ROM) and a random access memory (RAM). As one example, the processor 41 loads various control programs stored in the ROM of the memory 42 onto the RAM and executes the programs so as to implement the functions as the transmitting apparatus 10, the receiving apparatus 20, and the bandwidth adjusting apparatus 30. Depending on a target of the control, a plurality of controlling apparatuses 40 may be provided. The plurality of control apparatuses may be spaced from each other. The processor 41 may include a processor constituted by, for example, an application specific integrated circuit (ASIC), a field programmable gate array (FPGA), or a programmable logic device (PLD).

The following description will discuss the selection method by which the first selecting section 12 of the transmitting apparatus 10 selects a wireless communication line 15. For example, the selection method specified by the specifying section 11 may be a method for referring to a predicted bandwidth to determine, from among the plurality of wireless communication lines 15, a preferential line given preference to transmit the image data and set a backup line to which a transmission bandwidth can be allocated.

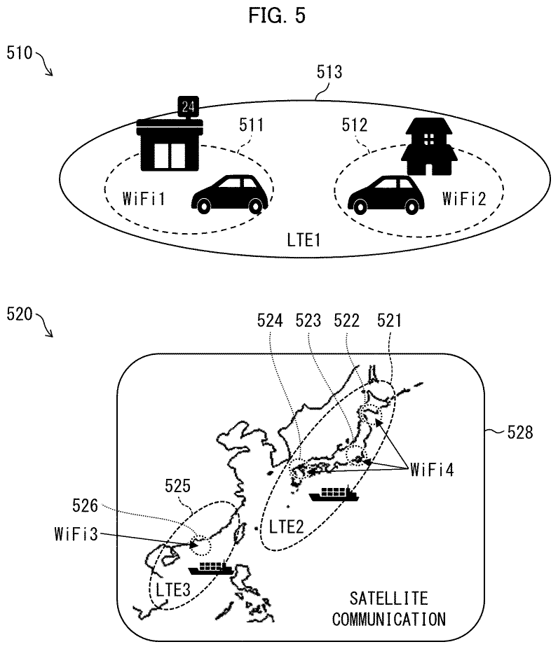

Alternatively, the selection method specified by the specifying section 11 may be a method for referring to a communication area in which the transmitting apparatus 10 is located, to determine an allocation bandwidth map. For example, assume that the transmitting apparatus 10 is mounted in a car, as illustrated in the reference numeral 510 of FIG. 5. In that case, the first selecting section 12 may determine the Wi-Fi (registered trademark) line as the preferential line in an area close to a Wi-Fi (registered trademark) connection point, such as a store neighborhood area 511 where Wi-Fi (registered trademark) 1 is available and a home neighborhood area 512 where Wi-Fi (registered trademark) 2 is available. This is because the Wi-Fi (registered trademark) line is basically available for free. Alternatively, the line to be used may be determined in advance in view of, for example, a communication speed and safety, as well as the cost. For example, in a case where the bandwidth of the Wi-Fi (registered trademark) is small, as in an area 513 or in a case where it is impossible to connect to the connection point, the first selecting section 12 may use the LTE1 line as an alternative line. The first selecting section 12 may set the satellite communication line as a backup line available in case neither the Wi-Fi (registered trademark) line nor the LTE line is usable.

Further, for example, assume that the transmitting apparatus 10 is mounted in a ship, as illustrated in the reference numeral 520 of FIG. 5. In that case, the selection method may be a method that uses a Wi-Fi (registered trademark) 3 line or a Wi-Fi (registered trademark) 4 line in domestic urban areas 522, 523, and 524 or in a foreign urban area 526, uses an LTE 2 line or an LTE 3 line in adjacent-sea areas 521 or 525, and selects the satellite communication line in the other ocean area 528. The selection method may be a method combining the method for determining a preferential line and the method for referring to a communication area to determine a wireless communication line.

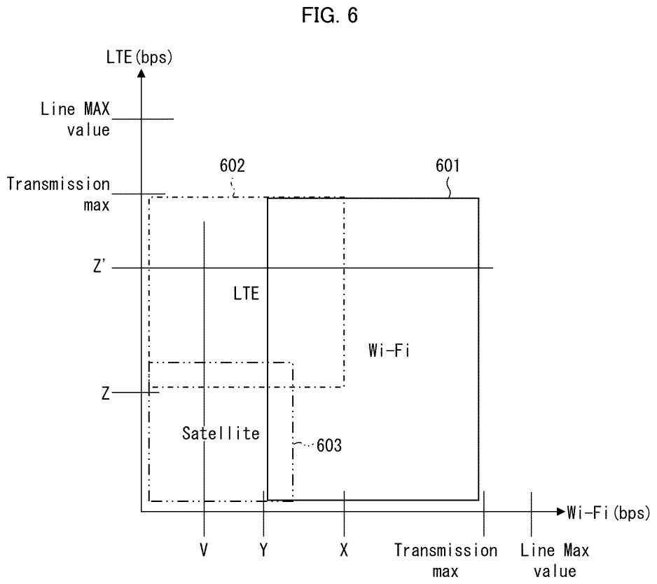

Alternatively, the selection method specified by the specifying section 11 may be a method for selecting one of a plurality of allocation bandwidth maps that are prepared in advance and that each indicate the transmission bandwidth allocated to each of the plurality of the wireless communication lines. The allocation bandwidth map shows, in a map form, a method for comparing the bandwidths (transmission bandwidths) via which the plurality of wireless communication lines can perform transmission, to determine a bandwidth to be used for each line. This method will be described with reference to the drawings in detail. FIGS. 6 to 9 are each a view schematically illustrating one example of the allocation bandwidth map selected by the first selecting section 12.

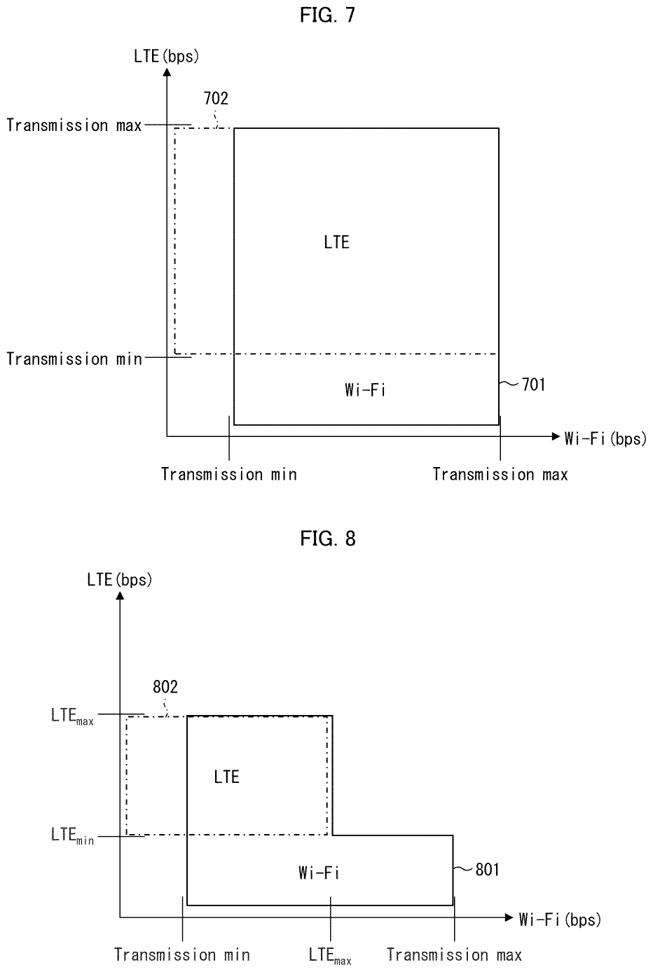

With reference to FIG. 6, the following description will discuss a basic thought process for selecting a line and a bandwidth with use of the allocation bandwidth map. In FIG. 6, the horizontal axis represents the bandwidth (bps) value of the Wi-Fi (registered trademark) line, and the vertical axis represents the bandwidth (bps) value of the LTE line. Assume that a zone 601 surrounded by a solid line represents a transmission bandwidth of the Wi-Fi (registered trademark) line, and that the minimum value and maximum value thereof are a value represented by “Y” and a value represented by “transmission max”, respectively. The transmission max value is smaller than the max value of the line. The transmission bandwidth in the allocation bandwidth map is a range of a bandwidth that is set for each wireless communication line and that suffices for transmission of favorable image data. Assume that a zone 602 surrounded by the dot-and-dash line represents the transmission bandwidth of the LTE line and that the minimum value and maximum value thereof are a value represented by “Z” and a value represented by “transmission max”, respectively. The transmission max value is smaller than the max value of the line. A zone 603 surrounded by a two-dot chain line represents a transmission bandwidth of the satellite line, and covers a zone that neither the Wi-Fi (registered trademark) line nor the LTE line can cover. In the following FIGS. 7 to 9, the same applies to the horizontal axis and the vertical axis, and the same applies to an illustrative aspect of the transmission bandwidth.

In a case where the predicted bandwidth of a certain line falls outside the transmission bandwidth thereof, the line is not used unconditionally. For example, assume that a predicted bandwidth at a certain time point is V for the Wi-Fi (registered trademark) line and Z′ for the LTE line. V is located outside a transmission bandwidth 601 of the Wi-Fi (registered trademark) line. In this case, the first selecting section 12 unconditionally selects the LTE line. The transmitting section 10 transmits image data in a bandwidth adjusted in accordance with the predicted bandwidth. In a case where a plurality of lines are available (in a range in which the transmission bandwidths overlap), the transmitting section 10 may perform the transmission via the plurality of lines. In that case, image data of good quality is selected on a receiving side. The image data of good quality is, for example, image data with the largest average bit rate.

Another thought process is as follows, for example. First, the Wi-Fi (registered trademark) line takes priority. If the predicted bandwidth of the Wi-Fi (registered trademark) is larger than X, the transmission via the LTE line is turned off (only the Wi-Fi (registered trademark) is used). The value of X may be determined as appropriate to some degree. For example, X can be 3 Mbps. If the predicted bandwidth of the Wi-Fi (registered trademark) is X or less, the transmission via the LTE line is enabled. In contrast, if the predicted bandwidth of the Wi-Fi (registered trademark) is smaller than Y, the transmission via the Wi-Fi (registered trademark) line is disabled. Y can be, for example, several hundreds of kbps.

FIG. 7 illustrates one example of the allocation bandwidth map in a case where a relatively simple selection method is used. In the example shown in FIG. 7, only the transmission bandwidth of the Wi-Fi (registered trademark) line and the transmission bandwidth of the LTE line are designated. They are each a range from “transmission min” to “transmission max”. In this case, in a case where the predicted bandwidths of the lines are included in the respective transmission bandwidths thereof, pieces of image data are transmitted in bandwidths adjusted independently for the lines. In that case, image data of good quality is selected on a receiving side. In a case where the allocation bandwidth map as illustrated in FIG. 7 is used, each of a plurality of lines performs the transmission whenever possible, and thus it is possible to transmit image data of maximum quality at the time of the transmission.

FIG. 8 illustrates one example of the allocation bandwidth map by a method for matching the maximum value of the transmission bandwidth of the Wi-Fi (registered trademark) line to the maximum value of the transmission bandwidth of the LTE line in a range in which the LTE line is usable. In the example illustrated in FIG. 8, in a range in which the LTE line is usable, the maximum value of the transmission bandwidth of the Wi-Fi (registered trademark) line is limited to LTEmax (the maximum value of the transmission bandwidth of the LTE line). In a range in which both the LTE line and the Wi-Fi (registered trademark) line are usable, pieces of image data are transmitted in independently adjusted bandwidths, and image data of good quality is selected on a receiving side. Such a selection method makes it unlikely that qualities of the images differ from each other while an image via the LTE line and an image via the Wi-Fi (registered trademark) line are switched. That is, it is possible to reduce change in quality of the image occurring while the lines are switched and to reduce the feeling of discomfort during the switching of the lines.

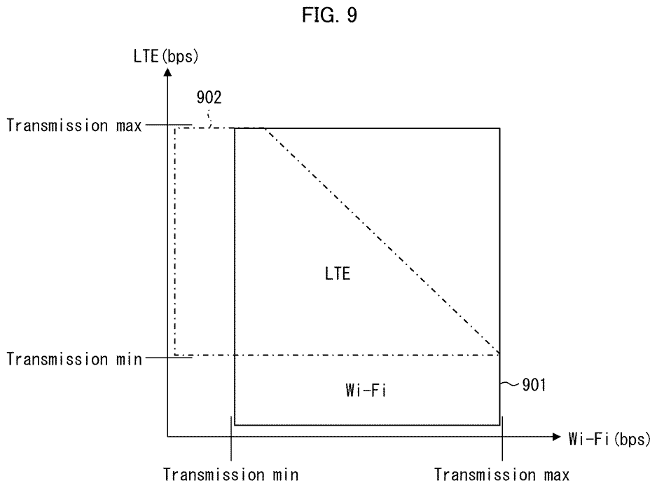

FIG. 9 illustrates one example of the allocation bandwidth map in which the bandwidth of the Wi-Fi (registered trademark) line is adjusted independently, and no transmission bandwidth is allocated to (no transmission is performed via) the LTE line in a bandwidth in which the Wi-Fi (registered trademark) line is usable. Specifically, a line with a slope of minus one is drawn from an intersection point of transmission min, which is the lower limit of the transmission bandwidth of the LTE line and transmission max, which is the upper limit of the transmission bandwidth of the Wi-Fi (registered trademark) line (the scale intervals of the horizontal and vertical axes are the same), and the transmission bandwidth of the LTE line located on the right of the line is prevented from being allocated. In a range in which both the LTE line and the Wi-Fi (registered trademark) line are usable, pieces of image data are transmitted in independently adjusted bandwidths, and image data of good quality is selected on a receiving side. Such a selection method makes it possible to optimize transmission so as to maintain the quality of the image as much as possible while giving preference to the Wi-Fi (registered trademark) line.

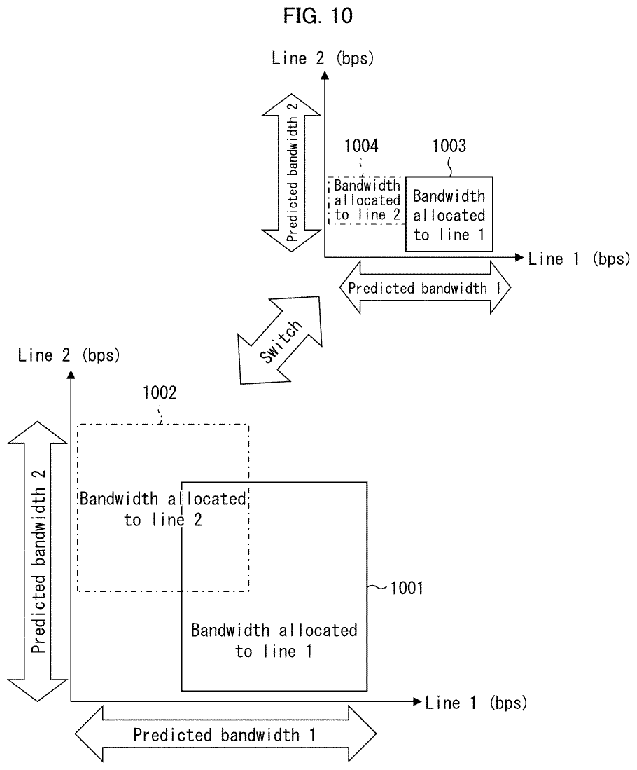

FIG. 10 is a view schematically showing that the allocation bandwidth maps illustrated in FIGS. 6 to 9 as examples are specified in accordance with change of predicted bandwidths of a plurality of lines. For example, the specifying section 11 may compare results of the predicted bandwidths of the plurality of lines to specify an allocation bandwidth map. For example, in the lower left map of the drawing, the transmission bandwidth 1001 of the line 1 and the transmission bandwidth 1002 of the line 2 partly overlap. In contrast, in the upper right map, the transmission bandwidth 1003 of the line 1 and the transmission bandwidth 1004 of the line 2 do not overlap. Thus, it is possible to specify an allocation bandwidth map to be used, in accordance with a policy of the user (for example, a stance on which condition, such as cost, communication speed, or safety is prioritized). Alternatively, the specifying section 11 may specify the allocation bandwidth map on the basis of a communication area in which the transmitting apparatus is located.

As described above, the information processing system 1A in accordance with the present example embodiment employs a configuration in which the first selecting section 12 specifies the wireless communication line that transmits the image, by a method for referring to the predicted bandwidth to determine, from among the plurality of wireless communication lines, a preferential line given preference to transmit the data and set a backup line to which a transmission bandwidth can be allocated. Therefore, the information processing system 1A in accordance with the present example embodiment provides an example advantage of making it possible to reduce the communication cost by preferentially selecting the Wi-Fi (registered trademark) line, in addition to the example advantage achieved by the information processing system 1 in accordance with the first example embodiment.

The information processing system 1A in accordance with the present example embodiment employs a configuration in which the first selecting section 12 specifies the wireless communication line that transmits the image, by a method for selecting one of a plurality of allocation bandwidth maps that are prepared in advance and that each indicate the transmission bandwidth allocated to each of the wireless communication lines. Therefore, the information processing system 1A in accordance with the present example embodiment provides an example advantage of making it possible to efficiently select a line by selecting one of a plurality of allocation bandwidth maps that are prepared in advance, in addition to the example advantage achieved by the information processing system 1 in accordance with the first example embodiment.

### (Configuration of Information Processing Apparatus 2A)

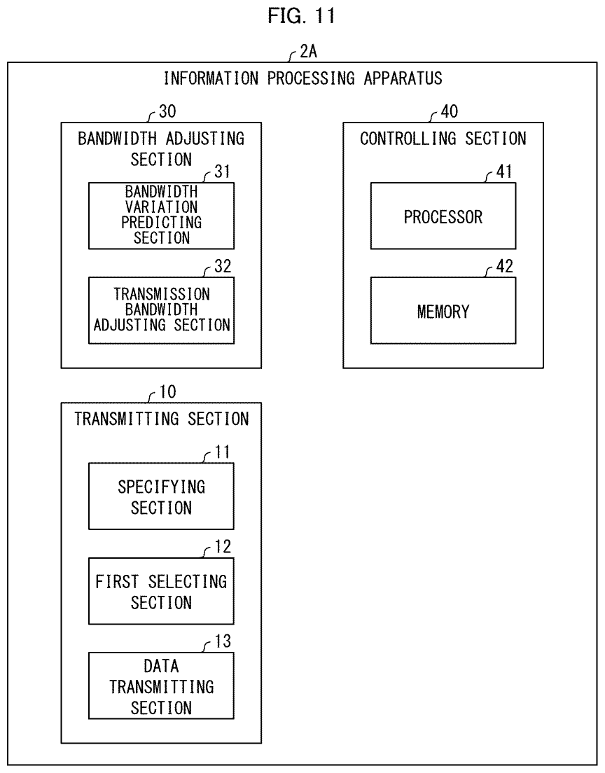

Now turning to FIG. 11, the following description will discuss an information processing apparatus 2A in accordance with the present example embodiment. FIG. 11 is a block diagram illustrating a configuration of the information processing apparatus 2A. The information processing apparatus 2A includes a transmitting section 10, a bandwidth adjusting section 30, and a controlling section 40.

The transmitting section 10 includes a specifying section 11, a first selecting section 12, and a data transmitting section 13. The bandwidth adjusting section 30 includes a bandwidth variation predicting section 31 and a transmission bandwidth adjusting section 32. The controlling section 40 includes a processor 41 and a memory 42. The configurations or functions of these sections are the same as the configurations or functions of the sections described for the information processing system 1A. Note that image data transmitted from the data transmitting section 13 is received by a receiving apparatus not illustrated.

As described above, in the information processing apparatus 2A in accordance with the present example embodiment, the first selecting section 12 employs the selection method for referring to a predicted bandwidth to determine a preferential line given preference to transmit image data, from among the plurality of wireless communication lines 15 and set a backup line to which a transmission bandwidth can be allocated. Alternatively, the first selecting section 12 employs the selection method for specifying a wireless communication line that transmits an image, by a method for selecting one of a plurality of allocation bandwidth maps that are prepared in advance and that each indicate the transmission bandwidth allocated to each of the wireless communication lines. Therefore, the information processing apparatus 2A in accordance with the present example embodiment provides the same example advantage as that achieved by the information processing system 1A.

### (Flow of Information Processing Method S2)

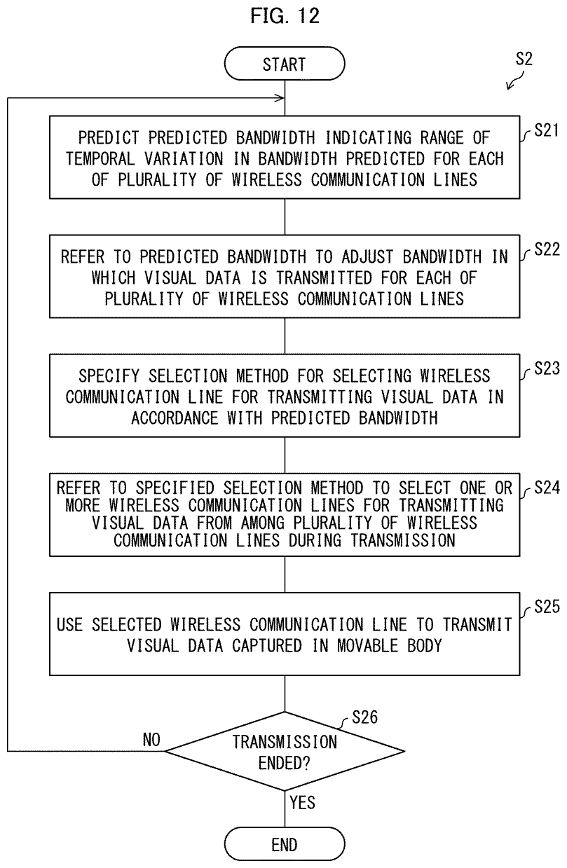

Now turning to FIG. 12, the following description will discuss a flow of an information processing method S2 in accordance with the present example embodiment. FIG. 12 is a flowchart illustrating a flow of the information processing method S2.

As illustrated in the drawing, the information processing method S2 includes a step S21 to a step S26. The step S21 is a step of, by at least one processor (for example, the bandwidth variation predicting section 31), predicting a predicted bandwidth indicating a range of temporal variation in a bandwidth, for each of a plurality of wireless communication lines.

The step S22 is a step of, by at least one processor (for example, the transmission bandwidth adjusting section 32), referring to the predicted bandwidth to adjust a bandwidth in which image data is transmitted, for each of the plurality of wireless communication lines.

The step S23 is a step of, by at least one processor (for example, the specifying section 11), specifying a selection method for selecting a wireless communication line that transmits image data, in accordance with the predicted bandwidth.

The step S24 is a step of, by at least one processor (for example, the first selecting section 12), referring to the specified selection method to select, during the transmission, one or more wireless communication lines that transmit image data, from among a plurality of wireless communication lines.

The step S25 is a step of, for example, by the data transmitting section 13, using the selected wireless communication line to transmit the image data captured in a movable body.

The step S26 is a step of, by at least one processor (for example, the controlling section 40), determining whether or not the transmission has been ended. In a case where in the step S26, the transmission is determined to have been ended (step S26: YES), the information processing is ended. In a case where in the step S26, the transmission is determined to have not been ended (step S26: NO), the process returns to the step S21.

Although not illustrated in FIG. 12, the information processing method S2 may further include receiving the image data transmitted and selecting, in a case where a plurality of pieces of the image data are received, one of the plurality of pieces of image data received.

The above information processing method S2 makes it possible to maintain stability of wireless communication, even in a case where the communication state changes during communication. For example, it is possible to stably transmit moving-image data without breaks or stops.

### Third Example Embodiment

The following description will discuss a third example embodiment of the present invention in detail with reference to the drawings. The same reference numerals are given to constituent elements having the same functions or configurations as those described in the first and second example embodiments, and descriptions thereof are not repeated.

### (Configuration of Information Processing System 1B)

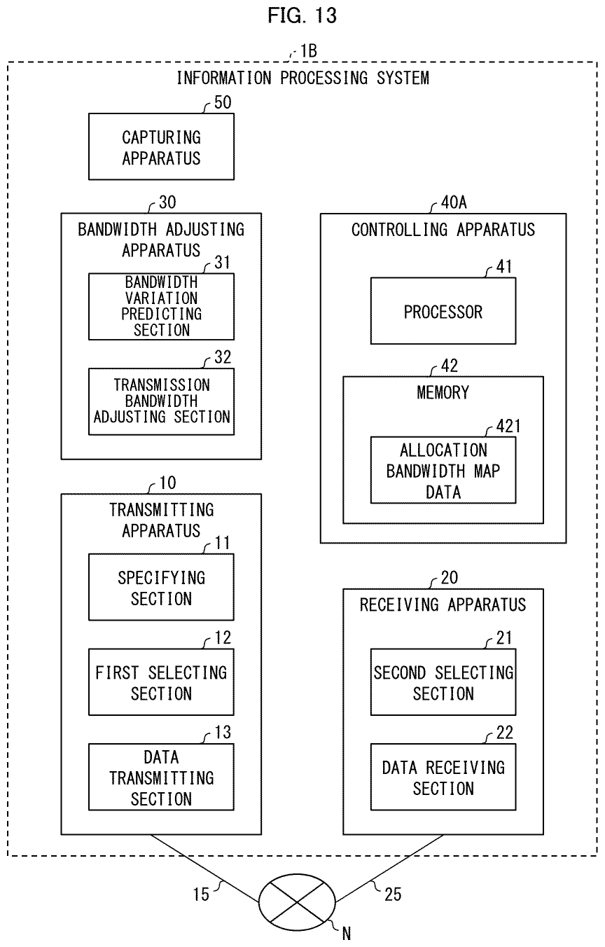

FIG. 13 is a block diagram illustrating a configuration of an information processing system 1B in accordance with the present third example embodiment. As illustrated in the drawing, the information processing system 1B includes a transmitting apparatus 10, a receiving apparatus 20, a bandwidth adjusting apparatus 30, a controlling apparatus 40A, and a capturing apparatus 50. Among these, the configurations or functions of the transmitting apparatus 10, the receiving apparatus 20, and the bandwidth adjusting apparatus 30 are the same as the configurations or functions of these apparatuses described for the information processing system 1A, and thus descriptions thereof are omitted.

The controlling apparatus 40A includes a processor 41 and a memory 42, and the memory 42 stores allocation bandwidth map data 421. The allocation bandwidth map data 421 is data on the allocation bandwidth map described for the information processing system 1A.

The capturing apparatus 50 captures image data. The image data captured is transmitted to the transmitting apparatus 10. The bandwidth adjusting apparatus 30 transmits, to the transmitting apparatus 10, adjusted bandwidth information for transmitting the image data. The transmitting apparatus 10 transmits the image data in an adjusted bandwidth via the selected wireless communication line 15. The receiving apparatus 20 receives the image data transmitted from the transmitting section 10. In a case where pieces of image data are transmitted via a plurality of wireless communication lines, the second selecting section 21 selects image data to be used.

As described above, the information processing system 1B in accordance with the present example embodiment employs a configuration in which the transmitting apparatus 10 refers to the allocation bandwidth map data 421 to select the wireless communication line and transmits the image data captured by the capturing apparatus 50 in an adjusted bandwidth. Therefore, the information processing system 1B in accordance with the present example embodiment provides an example advantage of making it possible to efficiently select a wireless communication line to transmit the image data, in addition to the example advantage achieved by the information processing system 1 in accordance with the first example embodiment.

### (Configuration of Information Processing Apparatus 2B)

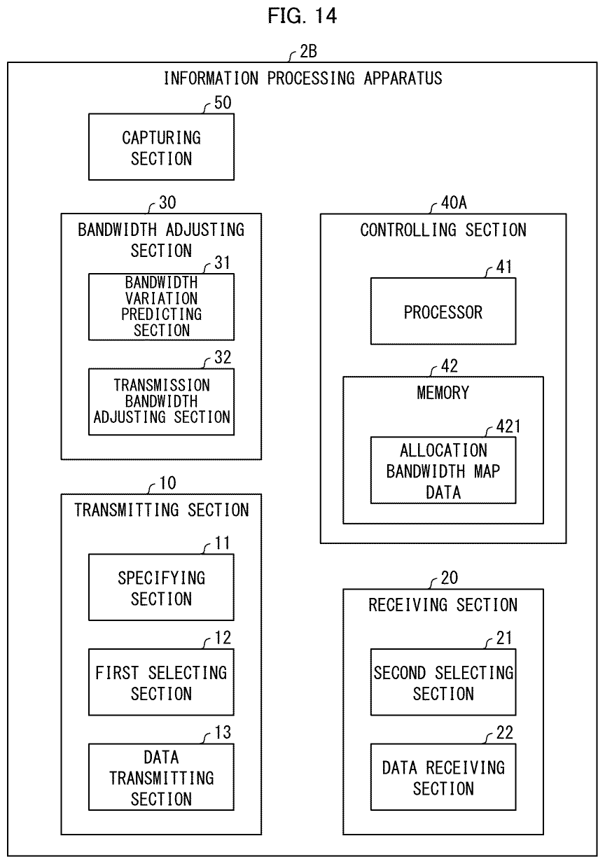

Now turning to FIG. 14, the following description will discuss an information processing apparatus 2B in accordance with the present third example embodiment. FIG. 14 is a block diagram illustrating a configuration of the information processing apparatus 2B. The information processing apparatus 2B is configured as a transmitting/receiving apparatus.

As illustrated in the drawing, the information processing apparatus 2B includes a transmitting section 10, a receiving section 20, a bandwidth adjusting section 30, a controlling section 40A, and a capturing section 50. Among these, the configurations or functions of the transmitting section 10 and the bandwidth adjusting section 30 are the same as the configurations or functions of the apparatuses corresponding to these which are described for the information processing apparatus 2A, and thus descriptions thereof are omitted.

The receiving section 20 includes a second selecting section 21 and a data receiving section 22. The second selecting section 21 and the data receiving section 22 have the same functions as those of these apparatuses described for the configuration of the information processing system 1A, and thus descriptions thereof are omitted. The controlling section 40A and the capturing section 50 have the same configurations or functions as the configurations or functions of the controlling apparatus 40A and the capturing apparatus 50 described for the configuration of the information processing system 1B, and thus descriptions thereof are omitted. The transmitting section 10 and the receiving section 20 are disposed in separate positions.

As described above, the information processing apparatus 2B in accordance with the present example embodiment employs a configuration in which the transmitting section 10 refers to the allocation bandwidth map data 421 to select the wireless communication line and transmits the image data captured by the capturing section 50 in an adjusted bandwidth. Therefore, the information processing apparatus 2B in accordance with the present example embodiment provides the same example advantage as that of the information processing system 1B.

### Software Implementation Example

Some or all of the functions of the information processing apparatuses 1, 1A, and 1B and the information processing apparatuses 2, 2A, and 2B (hereinafter, referred to as “information processing system and the like”) may be implemented by hardware such as an integrated circuit (IC chip), or may be implemented by software.

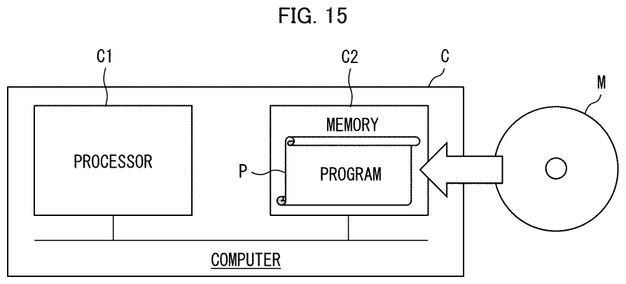

In the latter case, each of the information processing system and the like is implemented by, for example, a computer that executes instructions of a program that is software implementing the foregoing functions. FIG. 15 illustrates an example of such a computer (hereinafter, referred to as “computer C”). The computer C includes at least one processor C1 and at least one memory C2. The memory C2 stores a program P for causing the computer C to operate as the information processing system and the like. The processor C1 of the computer C retrieves the program P from the memory C2 and executes the program P, so that the functions of the information processing system and the like are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded in a case where the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### (Supplementary Note 1)

An information processing system including: a specifying means that specifies a selection method for selecting a wireless communication line for transmitting data obtained in a movable body, in accordance with a predicted bandwidth indicating a range of temporal variation in a bandwidth which variation is predicted for each of a plurality of the wireless communication lines; and a first selecting means that refers to the selection method specified, to select, while the data is being transmitted, one or more of the plurality of the wireless communication lines each for transmitting the data.

The above configuration makes it possible to maintain stability of wireless communication, even in a case where the communication state changes during communication.

### (Supplementary Note 2)

The information processing system in accordance with the supplementary note 1, wherein the selection method is a method for referring to the predicted bandwidth to determine, from among the plurality of the wireless communication lines, a preferential line given preference to transmit the data and set, from among the plurality of the wireless communication lines, a backup line to which a transmission bandwidth is allocatable.

According to the above configuration, it is possible to efficiently select a wireless communication line.

### (Supplementary Note 3)

The information processing system in accordance with the supplementary note 2, wherein the selection method is a method for selecting one of a plurality of allocation bandwidth maps that are prepared in advance and that each indicate the transmission bandwidth allocated to each of the plurality of the wireless communication lines.

According to the above configuration, it is possible to efficiently select a wireless communication line.

### (Supplementary Note 4)

The information processing system in accordance with any one of the supplementary notes 1 to 3, further including a bandwidth adjusting means that refers to the predicted bandwidth to adjust, for each of the plurality of the wireless communication lines, the bandwidth in which the data is transmitted.

According to the above configuration, it is possible to stably transmit data in accordance with the state of the wireless communication line.

### (Supplementary Note 5)

The information processing system in accordance with any one of the supplementary notes 1 to 4, further including a receiving means that receives the data transmitted, the receiving means including a second selecting means that selects one of a plurality of pieces of the data received, in a case where a plurality of the wireless communication lines are selected each for transmitting the data.

The above configuration makes it possible to retain only data of the best quality among the plurality of pieces of data transmitted via a plurality of wireless communication lines.

### (Supplementary Note 6)

The information processing system according to the supplementary note 3, wherein the selection method is a method for referring to a communication area in which a transmitting means is located, to determine the one of the plurality of allocation bandwidth maps.

According to the above configuration, it is possible to determine an optimum allocation bandwidth map in accordance with the communication area.

### (Supplementary Note 7)

The information processing system according to the supplementary note 3, wherein the selection method is a method for limiting, in a range in which a line configured according to a mobile communication standard is usable, a maximum value of the transmission bandwidth of a line configured according to a short-range wireless communication standard to a maximum value of the transmission bandwidth of the line configured according to the mobile communication standard.

The above configuration makes it possible to reduce the change in the quality of the image occurring while the lines are switched and to reduce the feeling of discomfort during the switching of the lines.

### (Supplementary Note 8)

The information processing system according to the supplementary note 3, wherein the selection method is a method for preventing, in a bandwidth in which a line configured according to a short-range wireless communication standard is usable, the transmission bandwidth from being allocated to a line configured according to a mobile communication standard.

The above configuration makes it possible to optimize transmission so as to maintain the quality of an image as much as possible while giving preference to a line configured according to a short-range wireless communication standard.

### (Supplementary Note 9)

An information processing apparatus including: a specifying means that specifies a selection method for selecting a wireless communication line for transmitting data obtained in a movable body, in accordance with a predicted bandwidth indicating a range of temporal variation in a bandwidth which variation is predicted for each of a plurality of the wireless communication lines; and a first selecting means that refers to the selection method specified, to select, while the data is being transmitted, one or more of the plurality of the wireless communication lines each for transmitting the data.

The above configuration makes it possible to provide the same example advantage as that achieved by the information processing system in accordance with the supplementary note 1.

### (Supplementary Note 10)

The information processing apparatus in accordance with the supplementary note 9, wherein the selection method is a method for referring to the predicted bandwidth to determine, from among the plurality of the wireless communication lines, a preferential line given preference to transmit the data and set, from among the plurality of the wireless communication lines, a backup line to which a transmission bandwidth is allocatable.

The above configuration makes it possible to provide the same example advantage as that achieved by the information processing system in accordance with the supplementary note 2.

### (Supplementary Note 11)

The information processing apparatus in accordance with the supplementary note 10, wherein the selection method is a method for selecting one of a plurality of allocation bandwidth maps that are prepared in advance and that each indicate the transmission bandwidth allocated to each of the plurality of the wireless communication lines.

The above configuration makes it possible to provide the same example advantage as that achieved by the information processing system in accordance with the supplementary note 3.

### (Supplementary Note 12)

The information processing apparatus in accordance with any one of the supplementary notes 9 to 11, further including a bandwidth adjusting means that refers to the predicted bandwidth to adjust, for each of the plurality of the wireless communication lines, the bandwidth in which the data is transmitted.

The above configuration makes it possible to provide the same example advantage as that achieved by the information processing system in accordance with the supplementary note 4.

### (Supplementary Note 13)

The information processing apparatus in accordance with any one of the supplementary notes 9 to 12, further including a receiving means that receives the data transmitted, the receiving means including a second selecting means that selects one of a plurality of pieces of the data received, in a case where a plurality of the wireless communication lines are selected each for transmitting the data.

The above configuration makes it possible to provide the same example advantage as that achieved by the information processing system in accordance with the supplementary note 5.

### (Supplementary Note 14)

The information processing apparatus in accordance with the supplementary note 11, wherein the selection method is a method for referring to a communication area in which a transmitting means is located, to determine the one of the plurality of allocation bandwidth maps.

The above configuration makes it possible to provide the same example advantage as that achieved by the information processing system in accordance with the supplementary note 6.

### (Supplementary Note 15)

An information processing method including: specifying a selection method for selecting a wireless communication line for transmitting data obtained in a movable body, in accordance with a predicted bandwidth indicating a range of temporal variation in a bandwidth which variation is predicted for each of a plurality of the wireless communication lines; and referring to the selection method specified, to select, while the data is being transmitted, one or more of the plurality of the wireless communication lines each for transmitting the data, the specifying and the referring being each carried out by at least one processor.

The above configuration makes it possible to provide the same example advantage as that achieved by the information processing system in accordance with the supplementary note 1.

### (Supplementary Note 16)

The information processing method in accordance with the supplementary note 15, wherein the selection method is a method for referring to the predicted bandwidth to determine, from among the plurality of the wireless communication lines, a preferential line given preference to transmit the data and set, from among the plurality of the wireless communication lines, a backup line to which a transmission bandwidth is allocatable.

The above configuration makes it possible to provide the same example advantage as that achieved by the information processing system in accordance with the supplementary note 2.

### (Supplementary Note 17)

The information processing method in accordance with the supplementary note 16, wherein the selection method is a method for selecting one of a plurality of allocation bandwidth maps that are prepared in advance and that each indicate the transmission bandwidth allocated to each of the plurality of the wireless communication lines.

The above configuration makes it possible to provide the same example advantage as that achieved by the information processing system in accordance with the supplementary note 3.

### (Supplementary Note 18)

The information processing method in accordance with any one of the supplementary notes 15 to 17, further including referring to the predicted bandwidth to adjust, for each of the plurality of the wireless communication lines, the bandwidth in which the data is transmitted.

The above configuration makes it possible to provide the same example advantage as that achieved by the information processing system in accordance with the supplementary note 4.

### (Supplementary Note 19)

The information processing method in accordance with any one of the supplementary notes 15 to 18, further including: receiving the data transmitted; and selecting one of a plurality of pieces of the data received, in a case where a plurality of the wireless communication lines are selected each for transmitting the data.

The above configuration makes it possible to provide the same example advantage as that achieved by the information processing system in accordance with the supplementary note 5.

### (Supplementary Note 20)

The information processing method in accordance with the supplementary note 17, wherein the selection method is a method for referring to a communication area in which a transmitting means is located, to determine the one of the plurality of allocation bandwidth maps.

The above configuration makes it possible to provide the same example advantage as that achieved by the information processing system in accordance with the supplementary note 6.

### (Supplementary Note 21)

An information processing program causing a computer to carry out: a process of specifying a selection method for selecting a wireless communication line for transmitting data obtained in a movable body, in accordance with a predicted bandwidth indicating a range of temporal variation in a bandwidth which variation is predicted for each of a plurality of the wireless communication lines; and a process of referring to the selection method specified, to select, while the data is being transmitted, one or more of the plurality of the wireless communication lines each for transmitting the data.

### (Supplementary Note 22)

A computer-readable non-transitory storage medium storing the information processing program in accordance with the supplementary note 21.

### Additional Remark 3

Furthermore, some of or all of the foregoing example embodiments can also be expressed as below.

An information processing system including at least one processor, the at least one processor carrying out: a process of specifying a selection method for selecting a wireless communication line for transmitting data obtained in a movable body, in accordance with a predicted bandwidth indicating a range of temporal variation in a bandwidth which variation is predicted for each of a plurality of the wireless communication lines; and a process of referring to the selection method specified, to select, while the data is being transmitted, one or more of the plurality of the wireless communication lines each for transmitting the data.

Note that the information processing system may further include a memory. The memory may store a program for causing the processor to carry out the specifying process and the selecting process. The program may be stored in a computer-readable non-transitory tangible storage medium.

### REFERENCE SIGNS LIST

1, 1A, 1B Information processing system
2, 2A, 2B Information processing apparatus
10 Transmitting apparatus (transmitting section)
11 Specifying section
12 First selecting section
13 Transmitting section
20 Receiving apparatus (receiving section)
21 Second selecting section
22 Receiving section
30 Bandwidth adjusting apparatus (bandwidth adjusting section)
31 Bandwidth variation predicting section
32 Bandwidth adjusting section
40, 40A Controlling apparatus (controlling section)
41 Processor
42 Memory
50 Capturing apparatus (capturing section)

What is claimed is:

1. An information processing system comprising at least one processor, the at least one processor carrying out:
a specifying process of specifying a selection method for selecting a wireless communication line for transmitting data obtained in a movable body, in accordance with a predicted bandwidth indicating a range of temporal variation in a bandwidth which variation is predicted for each of a plurality of the wireless communication lines; and
a first selecting process of referring to the selection method specified, to select, while the data is being transmitted, one or more of the plurality of the wireless communication lines each for transmitting the data.

2. The information processing system according to claim 1, wherein the selection method is a method for referring to the predicted bandwidth to determine, from among the plurality of the wireless communication lines, a preferential line given preference to transmit the data and set, from among the plurality of the wireless communication lines, a backup line to which a transmission bandwidth is allocatable.

3. The information processing system according to claim 2, wherein the selection method is a method for selecting one of a plurality of allocation bandwidth maps that are prepared in advance and that each indicate the transmission bandwidth allocated to each of the plurality of the wireless communication lines.

4. The information processing system according to claim 1, wherein the at least one processor further carries out a bandwidth adjusting process of referring to the predicted bandwidth to adjust, for each of the plurality of the wireless communication lines, the bandwidth in which the data is transmitted.

5. The information processing system according to claim 1, wherein the at least one processor further carries out a receiving process of receiving the data transmitted, and
the receiving process is a process of carrying out a second selecting process of selecting one of a plurality of pieces of the data received, in a case where a plurality of the wireless communication lines are selected each for transmitting the data.

6. The information processing system according to claim 3, wherein the selection method is a method for referring to a communication area in which a transmitting means is located, to determine the one of the plurality of allocation bandwidth maps.

7. The information processing system according to claim 3, wherein the selection method is a method for limiting, in a range in which a line configured according to a mobile communication standard is usable, a maximum value of the transmission bandwidth of a line configured according to a short-range wireless communication standard to a maximum value of the transmission bandwidth of the line configured according to the mobile communication standard.

8. The information processing system according to claim 3, wherein the selection method is a method for preventing, in a bandwidth in which a line configured according to a short-range wireless communication standard is usable, the transmission bandwidth from being allocated to a line configured according to a mobile communication standard.

9. An information processing apparatus comprising at least one processor, the at least one processor carrying out:
a specifying process of specifying a selection method for selecting a wireless communication line for transmitting data obtained in a movable body, in accordance with a predicted bandwidth indicating a range of temporal variation in a bandwidth which variation is predicted for each of a plurality of the wireless communication lines; and
a first selecting process of referring to the selection method specified, to select, while the data is being transmitted, one or more of the plurality of the wireless communication lines each for transmitting the data.

10. The information processing apparatus according to claim 9, wherein the selection method is a method for referring to the predicted bandwidth to determine, from among the plurality of the wireless communication lines, a preferential line given preference to transmit the data and set, from among the plurality of the wireless communication lines, a backup line to which a transmission bandwidth is allocatable.

11. The information processing apparatus according to claim 10, wherein the selection method is a method for selecting one of a plurality of allocation bandwidth maps that are prepared in advance and that each indicate the transmission bandwidth allocated to each of the plurality of the wireless communication lines.

12. The information processing according to claim 9, wherein the at least one processor further carries out a bandwidth adjusting process of referring to the predicted bandwidth to adjust, for each of the plurality of the wireless communication lines, the bandwidth in which the data is transmitted.

13. The information processing apparatus according to claim 9, wherein the at least one processor further carries out a receiving process of receiving the data transmitted, and
the receiving process is a process of carrying out a second selecting process of selecting one of a plurality of pieces of the data received, in a case where a plurality of the wireless communication lines are selected each for transmitting the data.

14. The information processing apparatus according to claim 11, wherein the selection method is a method for referring to a communication area in which a transmitting means is located, to determine the one of the plurality of allocation bandwidth maps.

15. An information processing method comprising:
specifying a selection method for selecting a wireless communication line for transmitting data obtained in a movable body, in accordance with a predicted bandwidth indicating a range of temporal variation in a bandwidth which variation is predicted for each of a plurality of the wireless communication lines; and
referring to the selection method specified, to select, while the data is being transmitted, one or more of the plurality of the wireless communication lines each for transmitting the data.

16. The information processing method according to claim 15, wherein the selection method is a method for referring to the predicted bandwidth to determine, from among the plurality of the wireless communication lines, a preferential line given preference to transmit the data and set, from among the plurality of the wireless communication lines, a backup line to which a transmission bandwidth is allocatable.

17. The information processing method according to claim 16, wherein the selection method is a method for selecting one of a plurality of allocation bandwidth maps that are prepared in advance and that each indicate the transmission bandwidth allocated to each of the plurality of the wireless communication lines.

18. The information processing method according to claim 15, further comprising referring to the predicted bandwidth to adjust, for each of the plurality of the wireless communication lines, the bandwidth in which the data is transmitted.

19. The information processing method according to claim 15, further comprising:
receiving the data transmitted; and
selecting one of a plurality of pieces of the data received, in a case where a plurality of the wireless communication lines are selected each for transmitting the data.

20. (canceled)

21. A non-transitory storage medium storing a program for causing the at least one processor to carry out the specifying process according to claim 9 and the first selecting process according to claim 9.
